(19) United States
(12) Patent Application Publication
(10) Pub. No.: US 2008/0084345 A1
(43) Pub. Date: Apr. 10, 2008

(54) BROADBAND MULTI-CHANNEL DETECTOR WITH SIGNAL AND JAMMING DISCRIMINATION

(75) Inventors: John A. Rougas, Liverpool, NY (US); Stephen E. McMahon, Homer, NY (US); Douglas Owen, Vernon Center, NY (US)

Correspondence Address: BURR & BROWN, PO BOX 7068, SYRACUSE, NY, 13261-7068, US

(73) Assignee: SENSIS CORPORATION, East Syracuse, NY (US)

(21) Appl. No.: 11/778,992

(22) Filed: Jul. 17, 2007

Related U.S. Application Data
(60) Provisional application No. 60/831,836, filed on Jul. 19, 2006.

(51) Int. Cl. G01S 7/38

(52) U.S. Cl. 342/14

(57) ABSTRACT

Methods of determining whether a jamming signal strength is adequate, comprising receiving a signal, determining first and second noise power levels of the signal in first and second ranges of frequencies, the first range being broader than and encompassing the second range, and calculating a ratio of the second noise power level divided by the first noise power level. Also, methods of determining whether a jamming signal strength is adequate, comprising receiving a signal, determining a phase difference between first and second frequency range phases of the signal, and calculating a statistical mean and/or a standard deviation of the phase difference. Also, systems for determining whether a jamming signal is adequate, computer-readable media for determining whether jamming signal strength is adequate, systems comprising means for transmitting a jamming signal, and systems comprising means for transmitting and receiving waveforms to users in the presence of protective jamming.

### CROSS-REFERENCE TO RELATED APPLICATION

This application claims the benefit of U.S. Provisional Patent Application No. 60/831,836, filed Jul. 19, 2006, the entirety of which is incorporated herein by reference.

### FIELD OF THE INVENTION

The present invention is directed to systems and methods for determining whether a jamming signal is adequate to prevent reception of signals within a near area. In some embodiments, the present invention is directed to electronic support measures for ground personnel with likely exposure to improvised explosive devices (IEDs). In some embodiments, the present invention is directed to systems and methods for monitoring local radio frequency environments and alerting a user when a jamming signal is deemed to be inadequate to preclude reception of a transmitted signal (e.g., an RF signal) that could be used to remotely trigger an improvised explosive device (IED) near the user, or when an unknown coherent signal (e.g., an RF signal) is detected that has comparatively high strength. In some embodiments, the present invention allows reliable communications between users equipped with the device in the presence of jamming signals.

### BACKGROUND OF THE INVENTION

Portable electronic radio frequency (RF) communication devices, such as cellular phones and personal digital assistants, provide convenient means for communicating while traveling between different locations. In many countries around the world, portable RF phone technology has spread rapidly principally due to the ready availability, familiarity and ease of use by the public, and the relatively low cost of infrastructure required for construction of networks. Unfortunately, portable RF technology is also used by militant groups in unstable regions, such as recently liberated countries or regions experiencing sectarian violence, as a triggering mechanism for improvised explosive devices (IEDs), specifically, remotely controlled improvised explosive devices (RC-IEDs). Other commonly available electronic RF devices used as remote triggering devices include vehicle alarm devices, garage door openers and low-cost radios in the Family Radio Service (FRS)/General Mobile Radio Service (GMRS) bands. The use of portable electronic RF devices for remotely triggering IEDs is a serious security issue because of high casualty rates and the availability and low cost of these portable RF devices.

The use of electronically triggered IEDs has become a serious security issue in regions dominated by non-traditional warfare. In these areas, generally recently liberated countries, cell phone technology has been propagated principally due to the ease and low cost of adaptation by the general population and the relatively low cost of infrastructure required for construction of a network (e.g., a nation-wide network). Other commonly available RF devices used for triggering IEDs in these areas of conflict include: vehicle alarm devices, garage door openers and low-cost radios in the Family Radio Service (FRS)/General Mobile Radio Service (GMRS) bands. The use of cell phones and other RF devices as remote triggers has proliferated to the point that casualty rates from IEDs frequently exceed the casualty rates from actual combat operations.

To counter these threats, mobile jamming systems, or jammers, are used by security forces, including the U.S. Department of Defense (DoD), to effectively deny reception of RF signals in the frequency ranges used by these RF devices. The RF signals emitted by a protective jammer provide a level of protection against the threat posed by remotely triggered devices, such as IEDs, in an area surrounding the location of the jammer, by emitting a strong signal in a range of frequencies which is likely to encompass the frequency of the signal used to trigger the remotely triggered device, thereby blocking reception by the device of a triggering signal.

Protective jamming systems, however, generally operate autonomously, and personnel being protected by a jamming signal typically have no indication as to whether the jamming signal is functioning or has been interrupted. In addition, individuals protected by a jamming signal are frequently required to move away from the vicinity of the jamming signal while conducting business and/or operations, whereby they may move to a location where the strength of the jamming signal is inadequate to block a triggering signal.

The effective range of a protective jamming signal is dependent on the topography of the environment surrounding the jammer. Protective RF jamming signals are most effective in the vicinity of the jammer and the level of protection provided decreases as the distance from the jammer increases. In an urban environment, obstructions, such as terrain and buildings, reduce the effective distance of a jamming signal. The estimated effective ranges of the RF transmitters identified as potential RC-IED triggering devices are summarized in Table 1 (found at http://www.southernce.com/cgi.bin/SoftCart.exe/range.htm?L+scstore+josy3749+108864 3303).

TABLE 1
Triggering Transmitter Effective Ranges

| Terrain | 0.5 W FRS | 1 W UHF GMRS | 2 W UHF GMRS | 2 W VHF MURS |
|---|---|---|---|---|
| Outside - | 1.5-2 miles | 2-3 miles | 3-4 miles | 3-5 miles |
| clear flat terrain | | | | |
| Suburban | 1-1.5 miles | 1-2 miles | 1.5-2 miles | 1.5-3 miles |
| neighborhood | | | | |
| Urban Area | 0.5-1.0 mile | 0.5-1.5 miles | 1-1.5 miles | 1-1.5 miles |
| Inside Buildings or | 0.5 miles or | 0.5-0.75 miles or | 1 mile or | 0.5 miles or |
| malls | 5 floors | 15 floors | 20 floors | 10 floors |
| Between buildings & | 0.125-0.5 miles | 0.5-1.0 mile | 0.5-2.0 miles | 1-3 miles |
| houses | | | | |
| Woodlands | 1-1.5 miles | 1-2 miles | 1.5-2 miles | 2-3 miles |
| (moderate vegetation) | | | | |
| Woodlands | 0.5-1.0 mile | 0.5-1.5 miles | 1-1.5 miles | 1.5-2 miles |
| (thick vegetation) | | | | |

Thus, individuals, particularly ground personnel, frequently have no real way of knowing in an absolute sense whether they are protected by the jamming device, especially as they move to different locations away from the proximity of a jamming signal. Personnel, e.g., ground combat personnel operating in urban areas, frequently have no way of knowing whether their location is within or outside of the area protected by the jamming signal. Because autonomous jamming signals are weakened by distance and obstructions, a jamming signal may fail to provide an adequate level of protection in areas assumed to be protected.

Some protective jamming is provided in so-called “backpack” configurations wherein a small team of dismounted combatants use a collaborative set of jamming units while patrolling hostile regions. In those situations, it may be necessary for the dismounted personnel to be able to effectively communicate while the jamming is actively protecting them.

There is therefore a need for a device which is capable of alerting an individual, such as ground combat personnel, when the strength of the jamming signal is insufficient to afford the expected level of protection, or when there is an actively transmitting device which is in close enough proximity to overcome the protection afforded by the jamming signal, and/or which is capable, when a need arises for effectively communicating over a localized region in the presence of protective jamming, of satisfying such need.

### SUMMARY OF THE INVENTION

The present invention provides methods and systems which, in some embodiments, measures the jamming power used to protect personnel (e.g., ground combat personnel) from electronically activated IEDs and alerting the user when either the jamming power is insufficient to afford protection or when there is an active device within close enough range to overcome the protection afforded by the jammer.

In some embodiments, the present invention provides a simple yet intelligent battery power device which are preferably lightweight and which can be worn by ground combat personnel to alert them when they may be exposed to radio frequency signals which may electronically activate IEDs.

According to a first aspect of the present invention, there is provided a method of determining whether a jamming signal strength is adequate, comprising:

receiving at least a first signal;

determining the power level of the first signal in a first range of frequencies;

determining the power level of the first signal in a second range of frequencies, the first range of frequencies being broader than and encompassing the second range of frequencies; and

calculating the ratio of the power level of the first signal in the second range of frequencies (narrowband) divided by the power level of the first signal in the first range of frequencies (broadband).

In some embodiments according to this aspect of the present invention, the method further comprises determining whether the ratio of the power level of the first signal in the first range of frequencies divided by the power level of the first signal in the second range of frequencies is below a threshold value. In some such embodiments, the method further comprises activating an alarm if the ratio is below the threshold value.

In some embodiments according to the first aspect of the present invention, the method further comprises:

receiving a plurality of additional signals; and

for each additional signal:
determining the power level of the additional signal in the first range of frequencies;
determining the power level of the additional signal in the second range of frequencies; and
calculating an additional signal second noise power level/first noise power level ratio, the additional signal second noise power level/first noise power level ratio being equal to the power level of the additional signal in the second range of frequencies divided by the power level of the additional signal in the first range of frequencies.
   In some such embodiments, the method further comprises determining whether any of the additional signal second noise power level/first noise power level ratios is below the first threshold ratio, and, in some cases, if so, activating an alarm.

According to a second aspect of the present invention, there is provided a method of determining whether a jamming signal strength is adequate, comprising:

receiving at least a first signal;

determining a first signal first noise power level, the first signal first noise power level being a power level of the first signal in a first range of frequencies; and

for each of a plurality of additional ranges of frequencies:
determining a first signal additional range noise power level, the first signal additional range noise power level being a power level of the first signal in the additional range of frequencies, the first range of frequencies being broader than and encompassing each of the plurality of additional ranges of frequencies; and
calculating a first signal additional range noise power level/first signal first noise power level ratio, the first signal additional range noise power level/first signal first noise power level ratio being equal to the first signal additional range noise power level divided by the first signal first noise power level.

In some embodiments according to the second aspect of the present invention, the method further comprises determining whether any of the first signal additional range noise power level/first signal first noise power level ratios is below a threshold additional range noise power level/first noise power level ratio, and, in some cases, if so, activating an alarm. In some such embodiments, the method further comprises activating an alarm if any of the first signal additional range noise power level/first signal first noise power level ratios is below the threshold additional range noise power level/first noise power level ratio, and, in some cases, if so, activating an alarm.

According to a third aspect of the present invention, there is provided a method of determining whether a jamming signal strength is adequate, comprising:

receiving at least a first signal and a second signal:

determining a phase difference between a first signal first frequency range phase and a first signal second frequency range phase, the first signal first frequency range phase being a first direct current indication of a phase of the first signal in a first range of frequencies, the first signal second frequency range phase being a second direct current indication of a phase of the first signal in a second range of frequencies, the first range of frequencies being broader than and encompassing the second range of frequencies, by subtracting the second direct current indication from the first direct current indication; and

calculating a statistical mean of the phase difference and a standard deviation of the phase difference.

In some embodiments according to the third aspect of the present invention, the method further comprises determining whether the statistical mean is below a threshold statistical mean, and, in some cases, if so, activating an alarm.

In some embodiments according to the third aspect of the present invention, the method further comprises determining whether the standard deviation is below a standard deviation mean, and, in some cases, if so, activating an alarm.

In some embodiments according to the third aspect of the present invention, the method further comprises receiving a plurality of additional signals, and, for each additional signal:
determining an additional signal phase difference between a first frequency range phase of the additional signal and a second frequency range phase of the additional signal, the first frequency range phase of the additional signal being a third direct current indication of a phase of the additional signal in the first range of frequencies, the second frequency range phase of the additional signal being a fourth direct current indication of a phase of the additional signal in the second range of frequencies, by subtracting the fourth direct current indication from the third direct current indication; and
calculating a statistical mean of the additional signal phase difference and a standard deviation of the additional signal phase difference.
   In some such embodiments, the method further comprises determining whether the statistical mean is below a threshold statistical mean, and/or determining whether the standard deviation is below a standard deviation mean, and, in some cases, if so, activating an alarm.

According to a fourth aspect of the present invention, there is provided any of the methods described above, wherein the method is computer-implemented.

According to a fifth aspect of the present invention, there is provided a system for determining whether a jamming signal is adequate, the system comprising:

at least one RF antenna;

at least one RF signal detector;

means for determining a first noise power level, the first noise power level being a power level of a signal in a first range of frequencies;

means for determining a second noise power level, the second noise power level being a power level of the signal in a second range of frequencies, the first range of frequencies being broader than and encompassing the second range of frequencies; and

means for calculating a second noise power level/first noise power level ratio for the signal, the first signal second noise power level/first noise power level ratio being equal to the second noise power level divided by the first noise power level.

In some embodiments according to the fifth aspect of the present invention, the system further comprises means for determining whether the second noise power level/first noise power level ratio is below a threshold second noise power level/first noise power level ratio. In some such embodiments, the system further comprises an alarm and means for activating the alarm if the second noise power level/first noise power level ratio is below the threshold second noise power level/first noise power level ratio.

According to a sixth aspect of the present invention, there is provided a system for determining whether a jamming signal is adequate, the system comprising:

at least one RF antenna;

at least one RF signal detector;

means for determining a first noise power level, the first noise power level being a power level of a first signal in a first range of frequencies;

means for determining, for each of a plurality of additional ranges of frequencies, an additional range noise power level, the additional range noise power level being a power level of the first signal in the additional range of frequencies, the first range of frequencies being broader than and encompassing each of the plurality of additional ranges of frequencies; and

means for calculating, for each of the plurality of additional ranges of frequencies, an additional range noise power level/first noise power level ratio, the additional range noise power level/first noise power level ratio being equal to the additional range noise power level divided by the first noise power level.

In some embodiments according to the sixth aspect of the present invention, the system further comprises means for determining whether any of the additional range noise power level/first noise power level ratios is below a threshold additional range noise power level/first noise power level ratio. In some such embodiments, the system further comprises an alarm and means for activating the alarm if any of the additional range noise power level/first noise power level ratios is below the threshold additional range noise power level/first noise power level ratio.

According to a seventh aspect of the present invention, there is provided a system for determining whether a jamming signal strength is adequate, the system comprising:

at least one RF antenna;

at least one RF signal detector;

means for receiving at least a first signal and a second signal:

means for determining a phase difference between a first signal first frequency range phase and a first signal second frequency range phase, the first signal first frequency range phase being a first direct current indication of a phase of the first signal in a first range of frequencies, the first signal second frequency range phase being a second direct current indication of a phase of the first signal in a second range of frequencies, the first range of frequencies being broader than and encompassing the second range of frequencies, by subtracting the second direct current indication from the first direct current indication; and

means for calculating a statistical mean of the phase difference and a standard deviation of the phase difference.

In some embodiments according to the seventh aspect of the present invention, the system further comprises means for determining whether the statistical mean is below a threshold statistical mean and/or whether the standard deviation is below a standard deviation mean.

According to a eighth aspect of the present invention, there is provided a computer-readable medium having computer-executable commands for:

determining first noise power level of a first signal, the first noise power level being a power level of the first signal in a first range of frequencies;

determining a first signal second noise power level, the first signal second noise power level being a power level of the first signal in a second range of frequencies, the first range of frequencies being broader than and encompassing the second range of frequencies; and

calculating a first signal second noise power level/first noise power level ratio, the first signal second noise power level/first noise power level ratio being equal to the first signal second noise power level divided by the first signal first noise power level.

According to a ninth aspect of the present invention, there is provided a computer-readable medium having computer-executable commands for:

determining a first noise power level of a first signal, the first noise power level being a power level of the first signal in a first range of frequencies; and

for each of a plurality of additional ranges of frequencies:
determining a first signal additional range noise power level, the first signal additional range noise power level being a power level of the first signal in the additional range of frequencies, the first range of frequencies being broader than and encompassing each of the plurality of additional ranges of frequencies; and
calculating a first signal additional range noise power level/first signal first noise power level ratio, the first signal additional range noise power level/first signal first noise power level ratio being equal to the first signal additional range noise power level divided by the first signal first noise power level.

According to a tenth aspect of the present invention, there is provided a computer-readable medium having computer-executable commands for:

receiving at least a first signal and a second signal:

determining a phase difference between a first signal first frequency range phase and a first signal second frequency range phase, the first signal first frequency range phase being a first direct current indication of a phase of the first signal in a first range of frequencies, the first signal second frequency range phase being a second direct current indication of a phase of the first signal in a second range of frequencies, the first range of frequencies being broader than and encompassing the second range of frequencies, by subtracting the second direct current indication from the first direct current indication; and

calculating a statistical mean of the phase difference and a standard deviation of the phase difference.

According to an eleventh aspect of the invention, there is provided a system comprising:

a low power RF transceiver;

a broadband RF antenna;

means for transmitting a pre-determined low power jamming signal in response to measured threshold crossings (e.g., when a power level ratio falls below a threshold power level ratio value, when a statistical mean falls below a threshold statistical mean value, or when a standard deviation is below a standard deviation mean).

According to a twelfth aspect of the invention, there is provided a system comprising:

a low power RF transceiver;

a broadband RF antenna; and

means for transmitting and receiving service approved voice and data communications waveforms to proximate users in the presence of protective jamming.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a block diagram of a multichannel RF detector.

### DETAILED DESCRIPTION OF THE PRESENT INVENTION

As noted above, some embodiments of the present invention comprise one or more RF antenna. Persons of skill in the art are familiar with and have ready access to a wide variety of RF antennas, and any suitable RF antenna can be employed, if desired, in the methods and systems in accordance with the present invention.

As noted above, some embodiments of the present invention comprise one or more RF signal detector. Persons of skill in the art are familiar with and have ready access to a wide variety of RF signal detectors, and any suitable RF signal detector can be employed, if desired, in the methods and systems in accordance with the present invention.

As noted above, some embodiments of the present invention comprise a computer-readable medium. Persons of skill in the art are familiar with and have ready access to a wide variety of computer-readable media (e.g., hard drives, dvd's, cd's, flash memory devices, etc.), and any suitable computer-readable medium can be employed, if desired, in the methods and systems in accordance with the present invention.

A critical requirement of devices in accordance with the present invention is that they be able to discriminate between the desired jamming signal and the clandestine transmitter used for triggering an IED.

As an example of a situation which raises a jamming device coverage issue, ground combat personnel routinely proceed on patrol away from a support vehicle. As personnel move in response to terrain or the needs of the mission, the open-loop and autonomously provided jamming signals from the support vehicle may weaken and fail to provide an adequate margin of protection.

Some embodiments of the present invention use commercial off-the-shelf (COTS) components to passively measure the signal strength provided by the protective jammer in each of a number of RF bands in which the clandestine operators are known to be exploiting RF technology. In each band so exploited, the noise power is measured and compared to the wideband noise power in a band encompassing the total of all of the bands defended against by the jammer. A threshold on the selective band noise power is established relative to the noise power in the wideband channel. If the signal from the jammer in any selective channel drops below a deterministic threshold, the user of the device of such embodiments will be alerted some means, e.g., by a physical means, which preferably does not endanger the user by sight or sound.

In other embodiments of the present invention, there are provided methods and devices in which the phase of signals present in a plurality of radio frequency (RF) bands in the local RF environment are measured.

Embodiments of the present invention are typically used in conjunction with a jamming signal from a protective jamming system, or jammer. The local RF environment is typically an area immediately surrounding the location of a jammer and extending outward, e.g., for a distance of a mile or more, depending on the topography and obstructions present in the environment.

The systems and methods of the present invention monitor the local radio frequency environment including the jamming signal. The jamming signal is adequate where the jamming signal precludes the reception of a transmitted RF signal that could be used to remotely trigger an improvised explosive device (IED) proximate to a device in accordance with the present invention. In some embodiments of the present invention, the RF threat environment that the device monitors comprises commercial GSM/CDMA cellular telephone frequency bands including 800-1000 MHz, 1700-2200 MHz and 2500-2700 MHz, MURS, FRS and GMRS transceivers operating in the VHF frequency bands including 30-88 MHz and 151-155 MHz, FRS and GMRS transceivers operating in the UHF frequency bands including 225-399.9 MHz and 462-468 MHz, as well as low UHF frequency transmitters such as garage door openers operating around 40.85 MHz.

Additionally, in various embodiments of the present invention, the system and method of the present invention includes a warning system or mechanism to warn the user when either the jamming signal is inadequate to preclude reception of a transmitted RF or when an unknown coherent RF signal is detected and the detected RF signal has sufficient strength to potentially overcome the jamming signal.

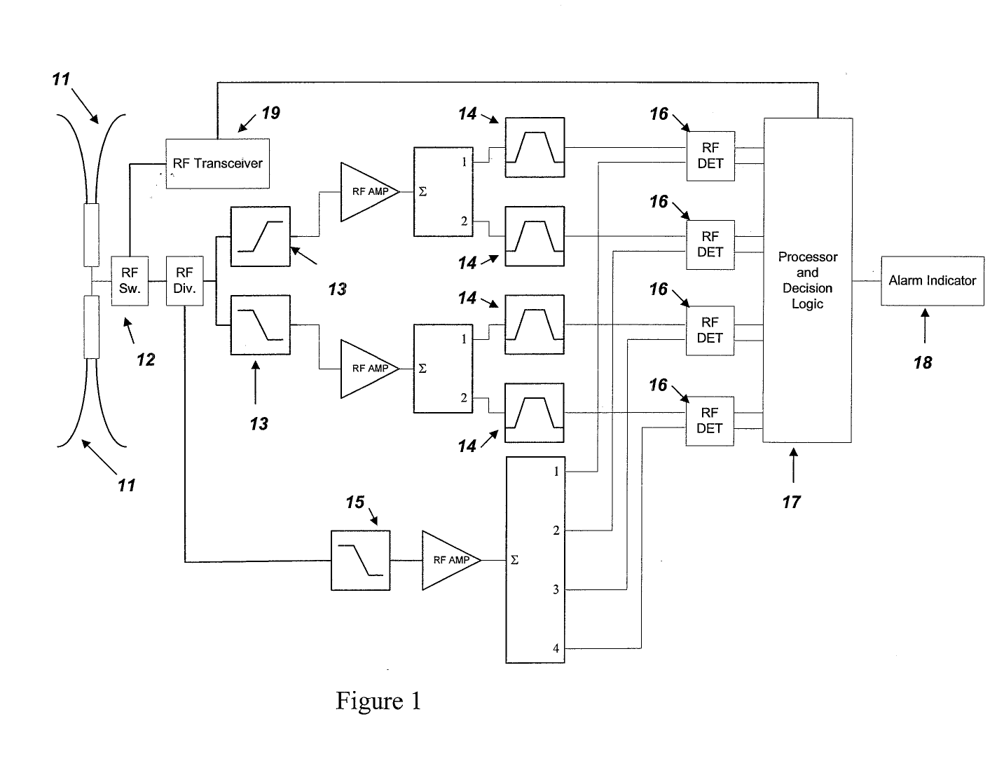

FIG. 1 shows a schematic block diagram of a representative embodiment according to the present invention. Referring to FIG. 1, an antenna 11 is provided which has (nominally) omni-directional gain over all known frequency bands used by the clandestine transmitters. A switching circuit 12 allows selection of the low power RF Transceiver 19 input/output of the normal receive path input. RF power splitting couples the received signals to diplexing filters 13 which provide a first level indication of the presence of protective jamming over the entire spectrum of applicability. Sub-band filtering 14 is provided in the upper portion of the diagram and the wideband channel 15 is maintained in the lower portion.

Within the sub-bands 14 of the embodiment depicted in FIG. 1, filtering is used to isolate the known clandestine transmitter frequencies. The protective jammer levels within those selective bands must be sufficient to render the clandestine transmitter ineffective. The system of this embodiment monitors the ratio of the selective level of jamming received to the wideband level of jamming within the RF detector 16 and a threshold level is established within the processor and decision logic 17 below which the jamming is deemed to be ineffective in that particular selective channel. A multi-stage alarm signal is provided for by the alarm indicator 18. Persons of skill in the art are familiar with and have ready access to a wide variety of audible and visual alarm devices suitable for bi-laterally converting computer-driven information into audio and/or data for human interpretation.

Within the sub-bands 14 of the embodiment depicted in FIG. 1, filtering is used to isolate the known clandestine transmitter frequencies. The protective jammer levels within those selective bands must be sufficient to render the clandestine transmitter ineffective. The system of this embodiment monitors the phase difference between the selective jamming received to the wideband jamming within the RF detector 16 and a measurement of the mean and standard deviation of the phase difference signal is made within the processor and decision logic 17. Comparison of the current measured means and standard deviations in each of the plurality of sub bands with the expected values is made within the processor and decision logic 17 to determine the values below which the jamming is deemed to be ineffective in that particular selective channel. A multi-stage alarm signal is provided for by the alarm indicator 18. Persons of skill in the art are familiar with and have ready access to a wide variety of audible and visual alarm devices suitable for bilaterally converting computer-driven information into voice and/or data for human interpretation.

In the first embodiment, the antenna comprises a combination of a loop antenna and a leaky coax antenna. The leaky coax antenna is formed of a flexible coax cable with sparse braiding and covers the higher frequency bands specified. The ends of the coax antenna are terminated, which provides constant feed-point impedance over the wide frequency range covered by the leaky coax antenna. The loop antenna is formed from the shield of the flexible coax cable and the loop antenna is cut to a length that is resonant at the lower frequency bands specified. In others embodiment, the antenna can instead comprise, e.g., a combination of a loop antenna and a stripline antenna. The stripline antenna is formed with a perforated ground plane and the loop antenna is the same as previously described. In some embodiments, the antenna is worn around the neck of the user to provide RF signal sampling in front of and behind the user.

The antenna included in some embodiments according to the present invention is capable of receiving RF signals in the HF, VHF, UHF, SHF, and EHF bands.

The RF detector (RF/IF gain detector) of some embodiments of the present invention monitors the local RF environment for signals transmitted in selected high frequency (HF), very high frequency (VHF), ultra high frequency (UHF), super high frequency (SHF), and extremely high frequency (EHF) bands in one or more narrow band channels and an RF wide band channel that includes each of the selected RF narrow band channels. The frequency bands monitored by the device of the present invention can include the RF bands used by Commercial GSM (Global System for Mobile Communications) cellular telephones and VHF/UHF wireless devices, including FRS, GMRS and MURS, for example.

In some embodiments, the RF detector of the device of the present invention comprises a closely matched pair of demodulating logarithmic amplifiers (log amps), each having a 60 dB measurement range. The signal strength or gain between the input RF signals is measured by taking the difference in the outputs of each of the log amps. The input signals are at different frequencies, one input channel being the RF broad band signal and the other input channel being one of the RF narrow band signals. In such embodiments, the RF detector accurately measures RF signal strength using a scaling of 30 mV/dB with a typical non-linearity of less than 0.5 dB, for example. In some embodiments, the log amps comprise a string of amplifiers in which every 40 mV/dB of signal strength causes the next amplifier in the string to add to the log amp's output signal. In such embodiments, the RF detector operates in a range from low frequency up to 2.7 GHz.

Further, the RF detector can be auto-adaptive within each of the selected RF narrow bands, enabling devices of the present invention to monitor the entire range of the selected narrow bands as well as specific frequencies of interest.

In some embodiments, the RF detector includes multiple linear amplifiers to increase the strength of signals in the broadband channel and selected narrowband channels for processing. In the first embodiment of the present invention, the RF detector signal processing can offset the narrow band and broad band signals by including one or more additional linear amplifiers in the narrow band signal path.

Where the dominant RF signal present is a jamming signal, the output of the log amps of the RF detector is similar to noise only, represented by the equation:
P0=10 log(Bf/Bin),
where: Bf=filter bandwidth and Bin=total spectrum width.

In some embodiments, the signal strength threshold for each selected RF narrow band channel is set based on an acceptable level of jamming signal in the narrow band channel relative to the level of jamming signal in the wideband channel. For example, where the signal strength threshold is set to −60 dBm at the antenna face, devices of the present invention have an effective range out to approximately 1.15 Km assuming a noise floor of approximately −78 dBm in the 2 GHz bandwidth with a 3 dB noise figure. Another method of setting the signal strength threshold for a selected RF narrow band channel is to set the signal strength threshold value equal to the measured wide band signal strength at the log amp output of the RF detector.

The measured signal strength of the RF signals present in each of the selected RF narrow band channels and the RF wideband channel will typically be deterministically scaled so as to be within the detector dynamic range which provides maximum sensitivity to the ratio of the particular RF narrow band channels to the RF wideband channel.

To increase frequency range, embodiments of the present invention can include a down-converter which converts received signals between 2.7 GHz and 5.7 GHz for processing by the RF detector. In some embodiments, the down converter is a super heterodyne down-converter. In one embodiment, the down-conversion is accomplished through a super heterodyne frequency multiplication method.

Turning now to a different aspect of the present invention, a major problem faced by a simple solution to monitoring the jammer power is the presence of one or more normal signals, such as those described above as being capable of remotely triggering IEDs. A simple RF detector will yield an output to either the undesired clandestine signal or the desired protective jamming signal. Some aspects of the present invention overcome this problem by using a phase detector in each of the selective channels, which compares the phase of the signals in the wideband channel with the phase of the same signal in the selective channel. Persons of skill in the art are familiar with, and have easy access to, a variety of phase detectors, and any such devices can be employed in such embodiments of the present invention. Since, by the Central Limit Theorem, the sum of random signals, such as noise, will be a random signal, the response of the phase detector output in each selective channel will be noise-like, having a higher alternating current than direct current component, when comparing protective jammer noise in both channels. However, should a coherent signal appear, such as those radiated by a clandestine transmitter, the signal will appear in the selective channel covering that clandestine transmitter and the broadband channel simultaneously. The output of the phase detector in that case is less noise-like, having a significantly higher ratio of direct current or low frequency than alternating current or higher frequency. Also, the signals will have differing statistical means and standard deviations. Devices according to this aspect of the invention exploit this difference to make a determination on the intensity of the clandestine signal relative to the desired broadband jamming signal and alerts the wearer should the signal ratios be at a level which would endanger the wearer.

In some embodiments, the system signal processing uses decision logic to discriminate between the AC component and DC component of the detected signals of the wide band channel and a selected RF narrow band channel, including coherent RF signals buried in the jamming signal. Where the AC component of the detected signal is higher than the DC/low frequency (LF) component of the detected signal at the output of the phase detector, the detected RF is most likely a random signal, such as noise. Where the DC/LF component of the detected signal is higher than the AC component of the detected signal at the output of the phase detector, the detected RF is a coherent RF signal that may be a threat. Thus, by discriminating on the AC/DC ratio of the signals present in the frequencies being monitored, the decision logic can make a decision as to whether a coherent signal source is likely present.

Similarly, in some embodiments, the system signal processing uses decision logic to discriminate between the mean and standard deviation differences of the detected signals of the wide band channel and a selected RF narrow band channel, including coherent RF signals buried in the jamming signal.

Additionally, embodiments of the device of the present invention can include a low power transmitter for transmitting a jamming signal proximate to the device and user when desired, e.g., when a second stage warning is triggered. In some embodiments, the signal transmitted by the low power RF transmitter provides a degree of protection, e.g., for approximately 50 feet around the user. In some of such embodiments, for example, the output signal of the low power transmitter is approximately 10 mW.

Additionally, some embodiments of the device of the present invention include a low power RF transceiver for transmitting and receiving encoded voice and/or encoded data with other users having similar if not identical devices while the users are within the coverage area of a protective jamming signal, even where the encoded voice and data signals are within the RF band being jammed by the protective jamming signal. In such embodiments of the device of the present invention, the low power RF transceiver is capable of transmitting and receiving at least one of the service-approved phase-encoded RF waveforms. Such devices of the present invention detect and do not jam the received service-approved waveforms for voice and data communications signals. The device of the present invention transmits and receives the service-approved waveforms both within the coverage area of a protective jamming signal and outside of the coverage area of a protective jamming signal.

The data communications signals include information signals and/or command signals. The voice and data communications signals can use the same service-approved waveform or may use different service-approved waveforms. In some embodiments, the device of the present invention will provide the user a means for listening to the received phase-encoded voice signal. In other embodiments, the device will provide a means to visually display the content of the received phase-encoded data signal to the user. In yet other embodiments, the device will provide a visual indication of the command transmitted in the received phase-encoded data signal to the user. In other embodiments, the device will provide a tactile stimulation means to alert the user. In some embodiments, the device of the present invention will provide a combination of two or more of the aforementioned visual indications, tactile stimulations, visual displays and listening means to the user. In some embodiments, the visual indication, tactile stimulation, visual display and listening means are operator selectable. In some of the aforementioned embodiments, the signal transmitted by the low power RF transceiver also provides a degree of protection around the user who is transmitting the signal. In some embodiments, for example, the output signal of the low power transmitter is approximately 10 mW.

The operation of some embodiments of the present invention is very simple and straightforward and needs minimal user operational training to operate properly. For example, in some such embodiments, the user simply needs to install the battery pack, turn the ON/OFF switch to ON and verify that the device of the present invention is receiving the jamming signal. Preferably, the user moves the ON/OFF switch on the device of the present invention to the ON position in an RF environment that is relatively benign, containing only normal RF transmissions including cellular traffic (i.e., the signal jammer is not transmitting). In some such embodiments, the battery pack contains four standard AA cells wired in series.

In some embodiments, devices according to the present invention include a security feature, which requires the user to insert of key in a personal keyfob (e.g., Microlatch®, RSA, etc). An internal decoder authenticates the user and starts a PIC boot, which initiates, sequences and collects/measures the internal BIT status of the device and displays the status of the device to the user. The user verifies the BIT status and post-BIT status (i.e., no jamming signal present). Such devices require no calibrations or adjustments in the field.

The user then moves to a position where the device (of such embodiments) is close to the signal jammer, when the jammer begins transmitting a jamming signal. The device provides an indication that the jamming signal has been received by any suitable display. In some embodiments, the user moves the device at least 10 m from the signal jammer to receive an indication that the device has detected the jamming signal.

After the user verifies that the device (of this embodiment) has detected a jamming signal, the user can then proceed as required, knowing that the device will warn the user if either the jamming signal strength falls below a predetermined threshold value and/or if an unknown coherent RF signal is detected and the detected RF signal has sufficient strength to overcome the jamming signal.

Some embodiments of the present invention further include a warning system or warning mechanism that warns the user when a jamming signal is not providing an adequate level of protection at the location of the device. The warnings can be provided by auditory warning means, a physical warning means, or a combination of both. The auditory warning means includes a signal broadcast in an audible range different sounds at differing volume levels. The auditory alerts are transmitted to a device worn by a user, such as a headset or ear communication device. The physical warning means includes tactile stimulation such as physical vibrations, different vibratory signal patterns and vibrations at differing levels of intensity. In some embodiments of the invention, the auditory and/or physical warning means can only be heard and/or felt by the user and does not endanger the user by sight or sound. In various embodiments, the warning mechanism is user-selectable between these modes.

Thus, embodiments of the system and method of the present invention enable a user to determine whether his or her current position is within or outside of the area protected by the jamming signal. In some embodiments, the device of the present invention warns the user by issuing a vibrator activate command with the vibrator set to different “ring tones” based on whether a first warning (caution level) or a second warning (danger level) is triggered.

In some embodiments, the device of the present invention provides two different and distinct warnings. In such embodiments, a first warning (caution level) is triggered when the device of the present invention determines that the signal strength of the jamming signal has fallen below a predetermined threshold value. A second warning (danger level) is triggered where the device of the present invention determines an unknown coherent RF signal is present and the unknown coherent signal has sufficient power (signal strength) to overcome the jamming signal.

In addition, for a jamming signal to provide protection to counter-identified RF remote triggering threats with a high probability of effectiveness, the effective range of the remote triggering devices and the lethal range of typical explosive devices, such as IEDs, was analyzed and 50 m was determined to provide adequate protection to individuals against these devices. Therefore, some embodiments of the device of the present invention further comprises a low power RF transmitter for transmitting a jamming signal proximate to the device and user when the second stage warning is triggered. This low power transmitter provides protection to a user for a distance, e.g., of approximately 50 m.

In some embodiments, the low power RF transmitter for transmitting a jamming signal proximate to an explosive device will also be capable of transmitting and receiving service approved encoded voice or data in the presence of a protective jamming signal among other nearby users of the invention.

In some embodiments which include an RF phase detector, the RF phase detector (RF/IF phase detector) can include at least a closely matched pair of demodulating logarithmic amplifiers (log amps), each having a 60 dB measurement range, and a multiplier type phase detector with precise phase balance that is driven by the signals appearing at the outputs of the log amps. The phase accuracy measurement is independent of signal level over a wide frequency range. The RF phase detector accurately measures phase using a scaling of 10 mV/degree with a typical non-linearity of less than 1 degree, for example. In one embodiment, the RF sensing capabilities are spiraled to enhance jammer detection capabilities. The RF phase detector operates in a range from low frequency up to 2.7 GHz. The RF phase detector can be integrated with the RF signal strength detector, as an RF/IF gain and phase detector, or may be a separate system element. Some embodiments include an RF/IF gain and phase detector, such as the AD8302, which covers frequencies from low frequency-to-2.7 GHz.

Since the jamming signal is a broad band jamming signal, the phase of the jamming signal is generally random. For each selected RF narrow band channel, the phase threshold can be set based on the measured jamming signal level in the narrow band channel and the wide band channel. For example, the signal phase threshold can be set to −60 dBm at the antenna face.

While the present invention has been particularly shown and described with reference to the preferred mode as illustrated in the drawing, it will be understood by one skilled in the art that various changes in detail may be effected therein without departing from the spirit and scope of the invention as defined by the claims.

1. A method of determining whether a jamming signal strength is adequate, comprising:
receiving at least a first signal;
determining a first signal first noise power level, said first signal first noise power level being a power level of said first signal in a first range of frequencies;
determining a first signal second noise power level, said first signal second noise power level being a power level of said first signal in a second range of frequencies, said first range of frequencies being broader than and encompassing said second range of frequencies; and
calculating a first signal second noise power level/first noise power level ratio, said first signal second noise power level/first noise power level ratio being equal to said first signal second noise power level divided by said first signal first noise power level.

2. A method as recited in claim 1, wherein said method further comprises determining whether said first signal second noise power level/first noise power level ratio is below a threshold second noise power level/first noise power level ratio.

3. A method as recited in claim 2, wherein said method further comprises activating an alarm if said first signal second noise power level/first noise power level ratio is below said threshold second noise power level/first noise power level ratio.

4. A method as recited in claim 1, wherein said method further comprises:
receiving a plurality of additional signals; and
for each said additional signal:
determining an additional signal first noise power level, said additional signal first noise power level being a power level of said additional signal in said first range of frequencies;
determining an additional signal second noise power level, said additional signal second noise power level being a power level of said additional signal in said second range of frequencies; and
calculating an additional signal second noise power level/first noise power level ratio, said additional signal second noise power level/first noise power level ratio being equal to said additional signal second noise power level divided by said additional signal first noise power level.

5. A method as recited in claim 4, wherein said method further comprises determining whether any of said additional signal second noise power level/first noise power level ratios is below said threshold second noise power level/first noise power level ratio.

6. A method as recited in claim 5, wherein said method further comprises activating an alarm if any of said additional signal second noise power level/first noise power level ratios is below said threshold second noise power level/first noise power level ratio.

7. A method of determining whether a jamming signal strength is adequate, comprising:
receiving at least a first signal;
determining a first signal first noise power level, said first signal first noise power level being a power level of said first signal in a first range of frequencies; and
for each of a plurality of additional ranges of frequencies:
determining a first signal additional range noise power level, said first signal additional range noise power level being a power level of said first signal in said additional range of frequencies, said first range of frequencies being broader than and encompassing each of said plurality of additional ranges of frequencies; and
calculating a first signal additional range noise power level/first signal first noise power level ratio, said first signal additional range noise power level/first signal first noise power level ratio being equal to said first signal additional range noise power level divided by said first signal first noise power level.

8. A method as recited in claim 7, wherein said method further comprises determining whether any of said first signal additional range noise power level/first signal first noise power level ratios is below a threshold additional range noise power level/first noise power level ratio.

9. A method as recited in claim 8, wherein said method further comprises activating an alarm if any of said first signal additional range noise power level/first signal first noise power level ratios is below said threshold additional range noise power level/first noise power level ratio.

10. A method of determining whether a jamming signal strength is adequate, comprising:
receiving at least a first signal;
determining a phase difference between a first signal first frequency range phase and a first signal second frequency range phase, said first signal first frequency range phase being a first direct current indication of a phase of said first signal in a first range of frequencies, said first signal second frequency range phase being a second direct current indication of a phase of said first signal in a second range of frequencies, said first range of frequencies being broader than and encompassing said second range of frequencies, by subtracting said second direct current indication from said first direct current indication; and
calculating a statistical mean of said phase difference and a standard deviation of said phase difference.

11. A method as recited in claim 10, wherein said method further comprises determining whether said statistical mean is below a threshold statistical mean.

12. A method as recited in claim 11, wherein said method further comprises activating an alarm if said statistical mean is below said threshold statistical mean.

13. A method as recited in claim 10, wherein said method further comprises determining whether said standard deviation is below a standard deviation mean.

14. A method as recited in claim 11, wherein said method further comprises activating an alarm if said standard deviation is below said standard deviation mean.

15. A method as recited in claim 10, wherein said method further comprises:
determining a first range/third range phase difference between said first signal first frequency range phase and a first signal third frequency range phase, said first signal third frequency range phase being a third direct current indication of a phase of said first signal in a third range of frequencies, said first range of frequencies being broader than and encompassing said first range of frequencies, by subtracting said third direct current indication from said first direct current indication; and
calculating a statistical mean of said first range/third range phase difference and a standard deviation of said first range/third range phase difference.

16. A method as recited in claim 15, wherein said method further comprises determining whether said statistical mean of said first range/third range phase difference is below a threshold statistical mean.

17. A method as recited in claim 16, wherein said method further comprises activating an alarm if said statistical mean of said first range/third range phase difference is below said threshold statistical mean.

18. A method as recited in claim 15, wherein said method further comprises determining whether said standard deviation of said first range/third range phase difference is below a standard deviation mean.

19. A method as recited in claim 18, wherein said method further comprises activating an alarm if said standard deviation of said first range/third range phase difference is below said standard deviation mean.

20. A method as recited in claim 10, wherein said method further comprises:
receiving a plurality of additional signals; and
for each said additional signal:
determining an additional signal phase difference between a first frequency range phase of said additional signal and a second frequency range phase of said additional signal, said first frequency range phase of said additional signal being a third direct current indication of a phase of said additional signal in an additional signal first range of frequencies, said second frequency range phase of said additional signal being a fourth direct current indication of a phase of said additional signal in an additional signal second range of frequencies, by subtracting said fourth direct current indication from said third direct current indication; and
calculating a statistical mean of said additional signal phase difference and a standard deviation of said additional signal phase difference.

21. A method as recited in claim 20, wherein said method further comprises determining whether said statistical mean of said additional signal phase difference is below a threshold statistical mean.

22. A method as recited in claim 21, wherein said method further comprises activating an alarm if said statistical mean of said additional signal phase difference is below said threshold statistical mean.

23. A method as recited in claim 20, wherein said method further comprises determining whether said standard deviation of said additional signal phase difference is below a standard deviation mean.

24. A method as recited in claim 21, wherein said method further comprises activating an alarm if said standard deviation of said additional signal phase difference is below said standard deviation mean.

25. A method as recited in claim 20, wherein said additional signal first range of frequencies for a first additional signal is substantially the same as said additional signal first range of frequencies for a second additional signal.

26. A method as recited in claim 20, wherein said additional signal first range of frequencies for a first additional signal is substantially the same as said first range of frequencies.

27. A method as recited in claim 1, wherein said method is computer-implemented.

28. A system for determining whether a jamming signal is adequate, said system comprising:
at least one RF antenna;
at least one RF signal detector;
means for determining a first noise power level, said first noise power level being a power level of a signal in a first range of frequencies;
means for determining a second noise power level, said second noise power level being a power level of said signal in a second range of frequencies, said first range of frequencies being broader than and encompassing said second range of frequencies; and
means for calculating a second noise power level/first noise power level ratio for said signal, said first signal second noise power level/first noise power level ratio being equal to said second noise power level divided by said first noise power level.

29. A system as recited in claim 28, wherein said system further comprises means for determining whether said second noise power level/first noise power level ratio is below a threshold second noise power level/first noise power level ratio.

30. A system as recited in claim 29, wherein said system further comprises an alarm and means for activating said alarm if said second noise power level/first noise power level ratio is below said threshold second noise power level/first noise power level ratio.

31. A system for determining whether a jamming signal is adequate, said system comprising:
at least one RF antenna;
at least one RF signal detector;
means for determining a first noise power level, said first noise power level being a power level of a first signal in a first range of frequencies;
means for determining, for each of a plurality of additional ranges of frequencies, an additional range noise power level, said additional range noise power level being a power level of said first signal in said additional range of frequencies, said first range of frequencies being broader than and encompassing each of said plurality of additional ranges of frequencies; and
means for calculating, for each of said plurality of additional ranges of frequencies, an additional range noise power level/first noise power level ratio, said additional range noise power level/first noise power level ratio being equal to said additional range noise power level divided by said first noise power level.

32. A system as recited in claim 31, wherein said system further comprises means for determining whether any of said additional range noise power level/first noise power level ratios is below a threshold additional range noise power level/first noise power level ratio.

33. A system as recited in claim 32, wherein said system further comprises an alarm and means for activating said alarm if any of said additional range noise power level/first noise power level ratios is below said threshold additional range noise power level/first noise power level ratio.

34. A system for determining whether a jamming signal strength is adequate, said system comprising:
at least one RF antenna;
at least one RF signal detector;
means for receiving at least a first signal and a second signal:
means for determining a phase difference between a first signal first frequency range phase and a first signal second frequency range phase, said first signal first frequency range phase being a first direct current indication of a phase of said first signal in a first range of frequencies, said first signal second frequency range phase being a second direct current indication of a phase of said first signal in a second range of frequencies, said first range of frequencies being broader than and encompassing said second range of frequencies, by subtracting said second direct current indication from said first direct current indication; and
means for calculating a statistical mean of said phase difference and a standard deviation of said phase difference.

35. A system as recited in claim 34, wherein said system further comprises means for determining whether said statistical mean is below a threshold statistical mean.

36. A system as recited in claim 35, wherein said system further comprises an alarm and means for activating said alarm if said statistical mean is below said threshold statistical mean.

37. A system as recited in claim 34, wherein said system further comprises means for determining whether said standard deviation is below a standard deviation mean.

38. A system as recited in claim 35, wherein said system further comprises an alarm and means for activating said alarm if said standard deviation is below said standard deviation mean.

39. A computer-readable medium having computer-executable commands for:
determining first noise power level of a first signal, said first noise power level being a power level of said first signal in a first range of frequencies;
determining a first signal second noise power level, said first signal second noise power level being a power level of said first signal in a second range of frequencies, said first range of frequencies being broader than and encompassing said second range of frequencies; and
calculating a first signal second noise power level/first noise power level ratio, said first signal second noise power level/first noise power level ratio being equal to said first signal second noise power level divided by said first signal first noise power level.

40. A computer-readable medium having computer-executable commands for:
determining a first noise power level of a first signal, said first noise power level being a power level of said first signal in a first range of frequencies; and
for each of a plurality of additional ranges of frequencies:
determining a first signal additional range noise power level, said first signal additional range noise power level being a power level of said first signal in said additional range of frequencies, said first range of frequencies being broader than and encompassing each of said plurality of additional ranges of frequencies; and
calculating a first signal additional range noise power level/first signal first noise power level ratio, said first signal additional range noise power level/first signal first noise power level ratio being equal to said first signal additional range noise power level divided by said first signal first noise power level.

41. A computer-readable medium having computer-executable commands for:
receiving at least a first signal and a second signal:
determining a phase difference between a first signal first frequency range phase and a first signal second frequency range phase, said first signal first frequency range phase being a first direct current indication of a phase of said first signal in a first range of frequencies, said first signal second frequency range phase being a second direct current indication of a phase of said first signal in a second range of frequencies, said first range of frequencies being broader than and encompassing said second range of frequencies, by subtracting said second direct current indication from said first direct current indication; and
calculating a statistical mean of said phase difference and a standard deviation of said phase difference.

42. A system comprising:
a low power RF transceiver;
a broadband RF antenna;
means for transmitting a jamming signal in response to a measured threshold crossing.

43. A system comprising:
a low power RF transceiver;
a broadband RF antenna; and
means for transmitting and receiving service-approved communications waveforms to at least one user in the presence of protective jamming.

44. A method as recited in claim 2, wherein said method further comprises transmitting a jamming signal if said first signal second noise power level/first noise power level ratio is below said threshold second noise power level/first noise power level ratio.

45. A method as recited in claim 2, wherein said method further comprises transmitting a service-approved communications waveforms to at least one user in the presence of protective jamming if said first signal second noise power level/first noise power level ratio is below said threshold second noise power level/first noise power level ratio.

46. A method as recited in claim 11, wherein said method further comprises transmitting a jamming signal if said statistical mean is below said threshold statistical mean.

47. A method as recited in claim 11, wherein said method further comprises transmitting a service-approved communications waveforms to at least one user in the presence of protective jamming if said statistical mean is below said threshold statistical mean.

48. A method as recited in claim 13, wherein said method further comprises transmitting a jamming signal if said standard deviation is below said standard deviation mean.

49. A method as recited in claim 13, wherein said method further comprises transmitting a service-approved communications waveforms to at least one user in the presence of protective jamming if said standard deviation is below said standard deviation mean.
